(19) United States
(12) Patent Application Publication
(10) Pub. No.: US 2010/0060191 A1
(43) Pub. Date: Mar. 11, 2010

(54) ELECTRIC-DISCHARGE-LAMP LIGHTING APPARATUS

(75) Inventors: Toru Ashikaga, Saitama (JP); Jae Hee Cho, Saitama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SANKEN ELECTRIC CO., LTD., NIIZA-SHI (JP)

(21) Appl. No.: 12/447,541

(22) PCT Filed: Oct. 30, 2006
(86) PCT No.: PCT/JP2006/321615

§ 371 Date: Apr. 28, 2009

(51) Int. Cl. H05B 41/36

(52) U.S. Cl. 315/291

(57) ABSTRACT

An electric-discharge-lamp lighting apparatus including: an inverter that converts a DC voltage to a high-frequency voltage; an insulating transformer for low voltage with a primary winding connected to an output end of the inverter; and a plurality of step-up transformers. In the electric-discharge-lamp lighting apparatus, a first series circuit formed by connecting primary windings of the plurality of step-up transformers in series to one another is connected to a secondary winding of the insulating transformer. In addition, one or more electric discharge lamps are connected respectively to secondary windings of the step-up transformers.

### TECHNICAL FIELD

The present invention relates to an electric-discharge-lamp lighting apparatus configured to light plural electric discharge lamps, such as cold cathode fluorescent lamps (CCFLs), fluorescent lamps with external electrodes, and fluorescent lamps.

### BACKGROUND ART

FIG. 1 is a diagram illustrating the configuration of a first example of conventional electric-discharge-lamp lighting apparatuses. The electric-discharge-lamp lighting apparatus includes: an AC power source 1; an AC/DC converter 3 to convert an AC voltage of the AC power source 1 to a DC voltage; an inverter 4 to convert the resultant DC voltage into a high-frequency voltage by making a control circuit 10 turn ON/OFF a switching element Q1 and a switching element Q2 alternately; plural step-up transformers T2 to T5 to increase the resultant high-frequency voltage to a range from 1000 V to 2000 V; electric-discharge lamps 11 to 14 that are CCFLs made to light by the high-frequency voltage thus increased; and current detectors 21 to 24 to detect the current passing through the electric-discharge lamps 11 to 14 respectively. The primary windings of the step-up transformers T2 to T5 are connected, in parallel with one another, to the switching element Q2 via a capacitor C1.

In the electric-discharge-lamp lighting apparatus, the AC/DC converter 3 insulates the primary side of each of the transformer T2 to T5 from the secondary side thereof, which eliminates the needs of insulation within each of the transformer T2 to T5. In addition, the low voltage of the AC/DC converter 3 (for example 24V) allows a small creepage distance to be accomplished. Moreover, the insulation achieved by the AC/DC converter 3 has an advantage of allowing the step-up transformers T2 to T5 to be small-sized since neither the insulation structure nor the standard for the insulation has to be taken into consideration. For these reasons, the electric-discharge-lamp lighting apparatus of this type is the most frequently found type of all the electric-discharge-lamp lighting apparatuses in the market.

The electric-discharge-lamp lighting apparatus of this type, however, is less attractive from the viewpoint of efficiency and price since the power conversion is carried out at two different steps—firstly by means of the AC/DC converter 3 and secondly by means of the step-up transformers T2 to T5. In addition, the means for balancing the currents passing respectively through the electric discharge lamps 11 to 14 depends on the leakage inductance caused between the primary winding and the secondary winding of each of the step-up transformers T2 to T5. Accordingly, the variations in properties among the electric discharge lamps 11 to 14 and among the step-up transformers T2 to T5 result in different values for the currents passing respectively therethrough. A large variation in properties among the electric discharge lamps 11 to 14 or among the step-up transformers T2 to T5 results in an unfavorable current balance among the electric discharge lamps 11 to 14.

Against the problem, another electric-discharge-lamp lighting apparatus has been devised in which an inverter is directly connected a primary-side power source with AC/DC converter 3 eliminated. In the electric-discharge-lamp lighting apparatus of this type, an inverter is connected directly either to a DC power source that rectifies an AC voltage of an AC power source and thus outputs a DC voltage or to a power source of direct current produced with a power-factor correction circuit (PFC).

FIG. 2 is a diagram illustrating a second example of conventional electric-discharge-lamp lighting apparatuses. In this electric-discharge-lamp lighting apparatus, a DC voltage is produced by rectifying an AC voltage of an AC power source 1 by means of a rectifying circuit 2 that includes a PFC. The DC voltage is converted to a high-frequency voltage by turning ON/OFF a switching element Q1 and a switching element Q2 alternately. An insulating transformer T1a is provided for the purpose of insulation. In addition, a secondary winding S1 of the insulating transformer T1a is made to produce a high-frequency voltage ranging from 1000 V to 2000 V, which is high enough to light electric discharge lamps 11 to 14.

Connection of the secondary winding S1 of the insulating transformer T1a to the plural electric discharge lamps 11 to 14 sometimes causes the following problems. Electric discharge lamps of the CCFL kind commonly have negative resistance characteristics. Once a voltage that is high enough to start the lighting is applied to the electric discharge lamps and the electric discharge lamps start lighting, the voltage needed for keeping the lighting of the electric discharge lamps from then on is lower than the voltage needed for starting the lighting thereof. In addition, the larger the current that passes through the electric discharge lamps is, the lower the voltage that the electric discharge lamps need becomes. Moreover, the starting the lighting of the plural electric discharge lamps cannot be accomplished simultaneously, but the plural electric discharge lamps start lighting one after another with certain time lags.

Specifically, when the first one of the electric discharge lamps starts lighting, a current passes through the secondary winding S1 of the insulating transformer T1a Then, a voltage drop occurs since the secondary winding S1 of the insulating transformer T1a has an impedance including a leakage inductance and a resistance component. As a consequence, a voltage that is high enough to start lighting the rest of the electric discharge lamps may possibly fail to be produced.

To address this problem, balancer transformers T6 to T8 made of ballast elements are inserted in series with the corresponding electric discharge lamps 11 to 14 so as to produce a voltage that is high enough to start lighting the rest of the electric discharge lamps. Each of the balancer transformers T6 to T8 is made of a common coil. The balancer transformer T6 produces a voltage so that the current passing through the electric discharge lamp 11 and the current passing through the electric discharge lamp 12 can have the same values. The balancer transformer T7 produces a voltage so that the current passing through the electric discharge lamp 13 and the current passing through the electric discharge lamp 14 can have the same values. If the two electric discharge lamps have completely the same current values, the currents passing through the two windings (the primary winding and the secondary winding) have the same values, so that the magnetic flux of the core of the balancer transformer is cancelled off resulting in a zero voltage produced between the windings.

A electric-discharge-lamp lighting apparatus disclosed in JP-A-11-238589 includes an inverter unit; a first resonance circuit which is connected to the output stage of the inverter unit and in which an inductor and a first capacitor are connected, in series, to each other; a second resonance circuit that includes at least one capacitor; a load circuit that includes plural electric discharge lamps; and an oscillation-control unit which makes the electric discharge lamps be lit with controlled light by changing the oscillating frequency of the inverter unit. The second resonance circuit and the load circuit are connected, in series, respectively to the two ends of the first capacitor of the first resonance circuit. The second resonance circuit and the load circuit are configured so as to make all the electric discharge lamps have the same lamp currents. In addition, the oscillating frequency of the inverter unit at the time when the electric discharge lamps are lit with controlled light is set at a value that is close to the natural resonance frequency of the first resonance circuit. Accordingly, lighting the plural electric discharge lamps stably even at low luminance levels is possible, and the difference in the light output among the electric discharge lamps can be made smaller.

### DISCLOSURE OF THE INVENTION

While only one of the electric discharge lamps is made to light (that is, while one of the two electric discharge lamps is not lighting), the current flows through only one of the two windings. In this case, a voltage of several hundreds of volts is produced between the windings. The voltage is used for the purpose of lighting the not-yet-lit electric discharge lamps. Accordingly, it is commonly the case that a balancer transformer should produce a high voltage. To produce a high voltage, each of the windings needs to have a larger number of turns so as to achieve a larger inductance. In addition, a certain breakdown voltage has to be secured for each of the balancer transformers, so that special attention has to be paid to the structure of the balancer transformer—for example, slot-division winding. For these reasons, balancer transformers have to be developed and manufactured so as to be especially dedicated to this end. As a consequence, the balancer transformers thus manufactured are expensive.

The insulating transformer T1a functions also as a step-up transformer and produces a high-frequency voltage in a range from 1000 V to 2000 V, approximately, which is high enough to light the electric discharge lamps 11 to 14. To this end, each of the windings of the insulating transformer T1a has to have a larger number of turns so as to achieve a larger inductance. In addition, the securing of a certain level of breakdown voltage for the insulating transformer T1a requires the slot-division winding while the insulating transformer T1a has to satisfy the safety standard by a larger creepage distance between the primary winding and the secondary winding. For these reasons and the like, the insulating transformer T1a is made larger in size and more expensive.

In addition, the electric-discharge-lamp lighting apparatus disclosed in JP-A-11-238589 includes the first resonance circuit, the second resonance circuit, the oscillation-control unit, and the like, so that the apparatus has a complex configuration and is expensive.

An object of the present invention, therefore, is to provide an electric-discharge-lamp lighting apparatus that is small-sized, highly efficient, and inexpensive.

To accomplish the above-mentioned object, a first invention provides an electric-discharge-lamp lighting apparatus including: an inverter that converts a DC voltage to a high-frequency voltage; an insulating transformer for low voltage with a primary winding connected to an output end of the inverter; and a plurality of step-up transformers, wherein a first series circuit formed by connecting primary windings respectively of the plurality of step-up transformers in series to one another is connected to a secondary winding of the insulating transformer, and one or more electric discharge lamps are connected to secondary windings respectively of the step-up transformers.

A second invention provides the electric-discharge-lamp lighting apparatus of the first invention with the following additional features. The inverter includes: a DC power source which rectifies an AC voltage and which thereby outputs a DC voltage; a second series circuit which is connected to two ends of the DC power source and which includes a first switching element and a second switching element connected in series to each other; and a third series circuit which is connected both to a first end of the DC power source and to a point where the first switching element and the second switching element are connected to each other and which includes a reactor, a capacitor, and a primary winding of the insulating transformer connected in series to one another.

A third invention provides the electric-discharge-lamp lighting apparatus of the first invention with the following additional features. The inverter includes: a DC power source which rectifies an AC voltage and which thereby outputs a DC voltage; second series circuit which is connected to two ends of the DC power source and which includes a first switching element and a second switching element connected in series to each other; and a third series circuit which is connected both to a first end of the DC power source and to a point where the first switching element and the second switching element are connected to each other and which includes a capacitor and a primary winding of the insulating transformer connected in series to one another.

A fourth invention provides the electric-discharge-lamp lighting apparatus of any one of the second and the third inventions further including a control unit that turns ON/OFF the first switching element and the second switching element alternately so that the current passing through the first series circuit becomes to a predetermined value.

A fifth invention provides the electric-discharge-lamp lighting apparatus of any one of the second and the third inventions further including a control unit that turns ON/OFF the first switching element and the second switching element alternately so that the current passing through the first series circuit becomes to a predetermined value, based on a total current obtained by summing up, for all of the plurality of step-up transformers, currents passing through the one or more electric discharge lamps connected respectively to the secondary windings of the plurality of step-up transformers.

A sixth invention provides the electric-discharge-lamp lighting apparatus according to any one of the second and the third inventions further including a control unit that turns ON/OFF the first switching element and the second switching element alternately, based on currents passing through the one or more electric discharge lamps connected to the secondary windings of any one of the plurality of step-up transformers, so that the current passing through the first series circuit becomes to a predetermined value.

In the electric-discharge-lamp lighting apparatus of any one of the first to the third inventions, the inverter is connected directly to the DC power source on the primary side. The insulating transformer for low voltage is used for the purpose of insulation. The primary windings of the plural step-up transformers are connected in series to the insulation output of the insulating transformer so that the voltage can be raised up. Thereby, the electric discharge lamps are lit. Accordingly, the currents passing respectively through the electric discharge lamps are substantially equal to one another even without a specific balance circuit, and there is only a single step of conversion, which results in a smaller loss during the conversion. In addition, no high voltage is needed for the secondary winding of the insulating transformer, so that an insulating transformer that is commonly used in a switching power source or the like can be used. As a consequence, it is possible to provide an electric-discharge-lamp lighting apparatus that is small-sized, highly efficient, and inexpensive.

In addition, in the electric-discharge-lamp lighting apparatus of any one of the fourth to the fifth inventions, the control unit turns ON/OFF the first switching element and the second switching element alternately so that the current becomes to a predetermined value. Accordingly, the currents passing respectively through the electric discharge lamps can be kept at constant values.

### BRIEF DESCRIPTION OF THE DRAWINGS

FIG. 1 is a diagram illustrating the configuration of a first example of conventional electric-discharge-lamp lighting apparatuses.

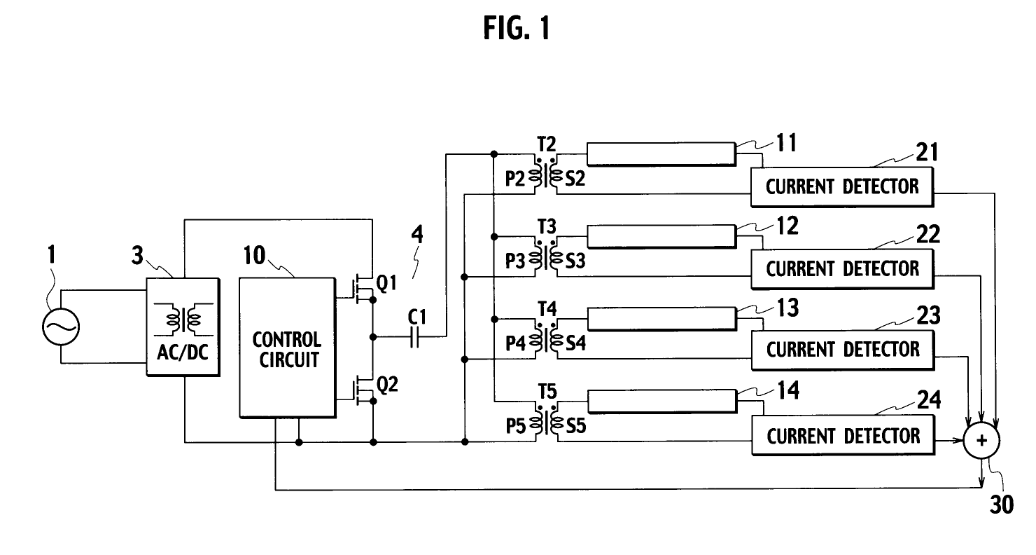

FIG. 2 is a diagram illustrating the configuration of a second example of conventional electric-discharge-lamp lighting apparatuses.

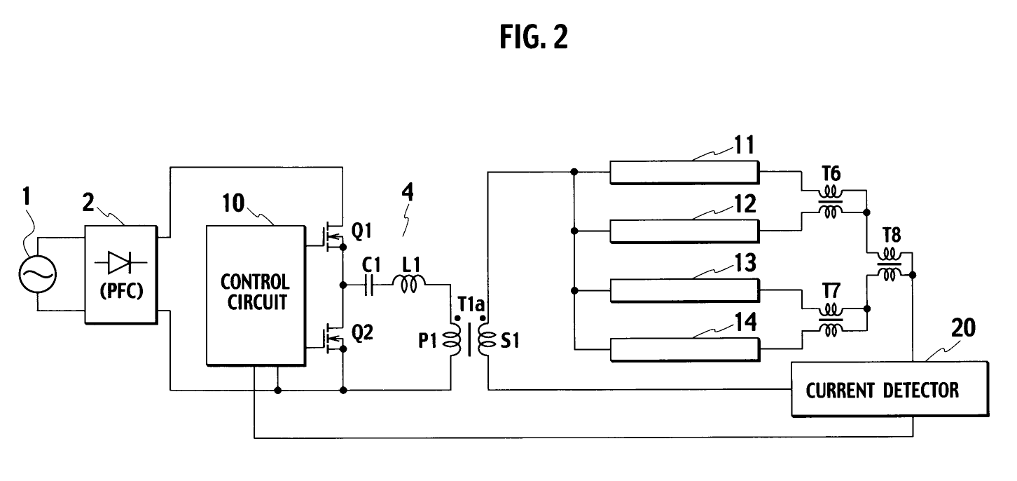

FIG. 3 is a diagram illustrating the configuration of an electric-discharge-lamp lighting apparatus according to Embodiment 1 of the present invention.

FIG. 4 is a diagram illustrating the configuration of an electric-discharge-lamp lighting apparatus according to Embodiment 2 of the present invention.

FIG. 5 is a diagram illustrating the configuration of an electric-discharge-lamp lighting apparatus according to Embodiment 3 of the present invention.

FIG. 6 is a diagram illustrating the configuration of an electric-discharge-lamp lighting apparatus according to Embodiment 4 of the present invention.

FIG. 7 is a diagram illustrating the configuration of an electric-discharge-lamp lighting apparatus according to Embodiment 5 of the present invention.

FIG. 8 is a diagram illustrating the configuration of an electric-discharge-lamp lighting apparatus according to Embodiment 6 of the present invention.

FIG. 9 is a diagram illustrating the configuration of an electric-discharge-lamp lighting apparatus according to Embodiment 7 of the present invention.

### BEST MODES FOR CARRYING OUT THE INVENTION

Embodiments of the present invention will be described in detail below with reference to the drawings.

### Embodiment 1

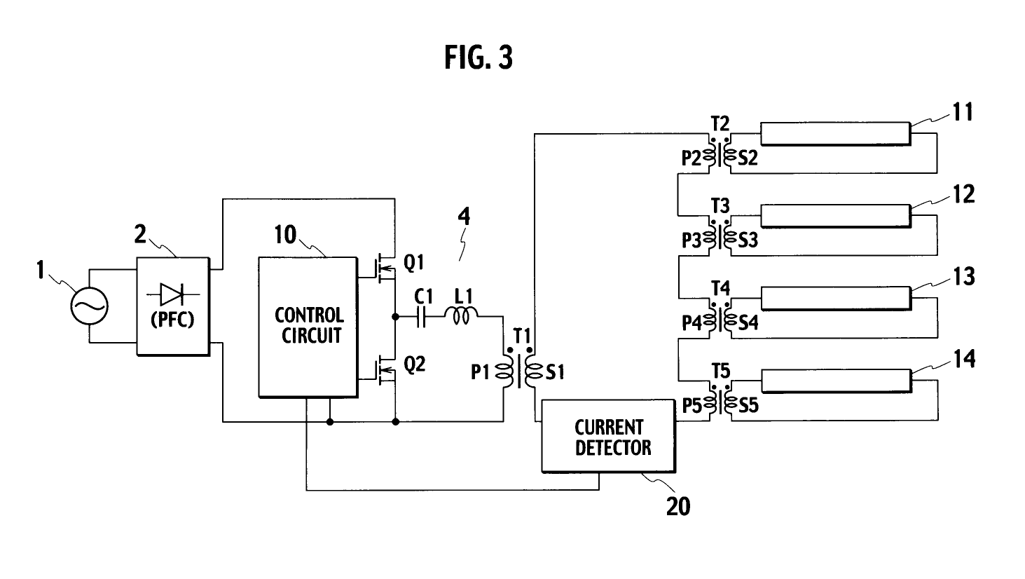

FIG. 3 is a diagram illustrating the configuration of an electric-discharge-lamp lighting apparatus according to Embodiment 1 of the present invention. The electric-discharge-lamp lighting apparatus includes: an AC power source 1; a rectifying circuit 2 including a PFC; an inverter 4; an insulating transformer T1 for low voltage, such as one with an output of 24 V; step-up transformers T2 to T5 that increase the voltage up to a range from 1000 V to 2000 V (corresponding to plural step-up transformers of the present invention); and electric discharge lamps 11 to 14. Some of the examples of the electric discharge lamps 11 to 14 are: cold-cathode tubes; fluorescent lamps with external electrodes; and fluorescent lamps. The electric discharge lamps used here are cold-cathode tubes.

The rectifying circuit 2 rectifies the AC voltage of AC power source 1, improves the power factor, and outputs a DC voltage to the inverter 4. The AC power source 1 and the rectifying circuit 2 combined together correspond to a DC power source of the present invention.

The inverter 4 includes: a switching element Q1 made of a MOSFET or the like; a switching element Q2 made of a MOSFET or the like; a control circuit 10 (corresponding to a control unit of the present invention); a capacitor C1; and a reactor L1. The inverter 4 converts a DC voltage to a high-frequency voltage by making the control circuit 10 turn ON/OFF the switching element Q1 and switching element Q2 alternately, and resonates the high-frequency voltage with the reactor L1 and the capacitor C1 so as to produce a sinusoidal high-frequency voltage in a primary winding P1 of the insulating transformer T1.

The switching element Q1 and the switching element Q2 are connected in series to each other and in parallel with the rectifying circuit 2. A first one of the two ends of the capacitor C1 is connected to the point where the switching element Q1 and the switching element Q2 are connected to each other, and the second end of the capacitor C1 is connected to the primary winding P1 of the insulating transformer T1 with the reactor L1 set in between. The reactor L1 is formed by a leakage inductance between the primary winding P1 and a secondary winding S1 of the insulating transformer T1.

Primary windings P2 to P5 respectively of the plural step-up transformers T2 to T5 are connected in series to one another so as to form a first series circuit. Both the first series circuit and a current detector 20 are connected in series to the two ends of the secondary winding S1 of the insulating transformer T1. The electric discharge lamp 11 is connected to the two ends of a secondary winding S2 of the step-up transformer 2. The electric discharge lamp 12 is connected to the two ends of a secondary winding S3 of the step-up transformer 3. The electric discharge lamp 13 is connected to the two ends of a secondary winding S4 of the step-up transformer 4. The electric discharge lamp 14 is connected to the two ends of a secondary winding S5 of the step-up transformer 5.

The current detector 20 detects the current passing through the first series circuit. The control circuit 10 turns ON/OFF the switching element Q1 and the switching element Q2 alternately so that the current detected by the current detector 20 becomes to a predetermined value. The control of the current is accomplished through an ON/OFF duty control on the switching element Q1 and the switching element Q2.

Subsequently, descriptions will be given as to the operation of the electric-discharge-lamp lighting apparatus of Embodiment 1 with the above-described configuration. To begin with, a DC voltage is obtained by making the rectifying circuit 2 rectify the AC voltage of the AC power source 1, and the resultant DC voltage is converted to a sinusoidal high-frequency voltage by turning ON/OFF the switching element Q1 and switching element Q2 alternately and by using the capacitor C1 and the reactor L1.

The resultant high-frequency voltage is changed by means of the insulating transformer T1, and the high-frequency voltage with the voltage thus changed is applied to primary winding P2 of the step-up transformer T2 to the primary winding P5 of the step-up transformer T5 connected, in series, to one another. With the voltage thus applied to, the same current passes through all primary winding P2 of the step-up transformer T2 to the primary winding P5 of the step-up transformer T5.

If the exciting impedance of the step-up transformers T2 to T5 is sufficiently higher than the impedance, converted to the value for input, at the time when the electric discharge lamps 11 to 14 are lit, the step-up transformers T2 to T5 act as current transformers. As a consequence, the same current can be supplied to each of the electric discharge lamps 11 to 14. If one of the electric discharge lamps 11 to 14 has not been lit yet, the impedance of the step-up transformer for the not-yet-lit electric discharge lamp rises up and the voltage also rises up. The voltage thus risen up is high enough to light the not-yet-lit electric discharge lamp. For this reason, no balance circuit especially dedicated for this purpose is necessary.

The primary currents of the step-up transformers T2 to T5 are proportional to the currents passing through the electric discharge lamps 11 to 14. Accordingly, the current detector 20 detects the current on the secondary-winding side of the insulating transformer T1, and the control circuit 10 executes an ON/OFF duty control to turn ON/OFF the switching element Q1 and the switching element Q2 alternately so that the current detected by the current detector 20 becomes to a predetermined value. As a consequence, the currents passing through the electric discharge lamps 11 to 14 can have constant values.

The secondary voltage of the insulating transformer T1 can be set up arbitrarily by the voltage gains of the step-up transformers T2 to T5, so that the insulating transformer T1 can work with the SELV (safety extra low voltage) of the safety standard. In addition, the insulating transformer T1 operates on low voltage, so that the creepage distance of the insulating transformer T1 can be shortened. The insulation between the primary side and the secondary side accomplished by the insulating transformer T1 eliminates the need for insulation within each of the step-up transformers T2 to T5.

In addition, since the current is detected on the low-voltage side, the current detector 20 can be small-sized. Moreover, since the secondary winding S1 of the insulating transformer T1 does not need a high voltage, an insulating transformer that is commonly used in a switching power source and the like can be used as the insulating transformer T1. Furthermore, since no AC/DC converter 3 is used, there is only a single conversion step, which reduces the conversion loss and contributes to an improvement in the efficiency. What is made possible thereby is providing an electric-discharge-lamp lighting apparatus that is small-sized, highly-efficient, and inexpensive.

### Embodiment 2

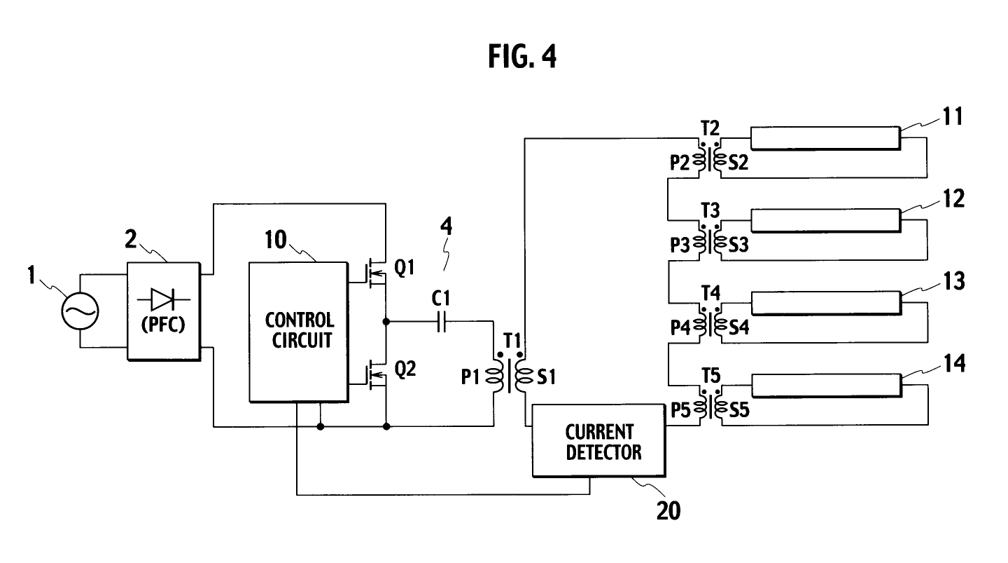

FIG. 4 is a diagram illustrating the configuration of an electric-discharge-lamp lighting apparatus according to Embodiment 2 of the present invention. The points that distinguish the electric-discharge-lamp lighting apparatus of Embodiment 2 shown in FIG. 4 from the electric-discharge-lamp lighting apparatus of Embodiment 1 shown in FIG. 3 are the elimination of the reactor L1; and the connection of a series circuit including the capacitor C1 and the primary winding P1 of the insulating transformer T1 to the two ends of the switching element Q2. The rest of the configuration of the apparatus of Embodiment 2 is identical to its counterpart of Embodiment 1.

The effects obtained by the use of the electric-discharge-lamp lighting apparatus of Embodiment 1 are obtainable according to the electric-discharge-lamp lighting apparatus of Embodiment 2.

### Embodiment 3

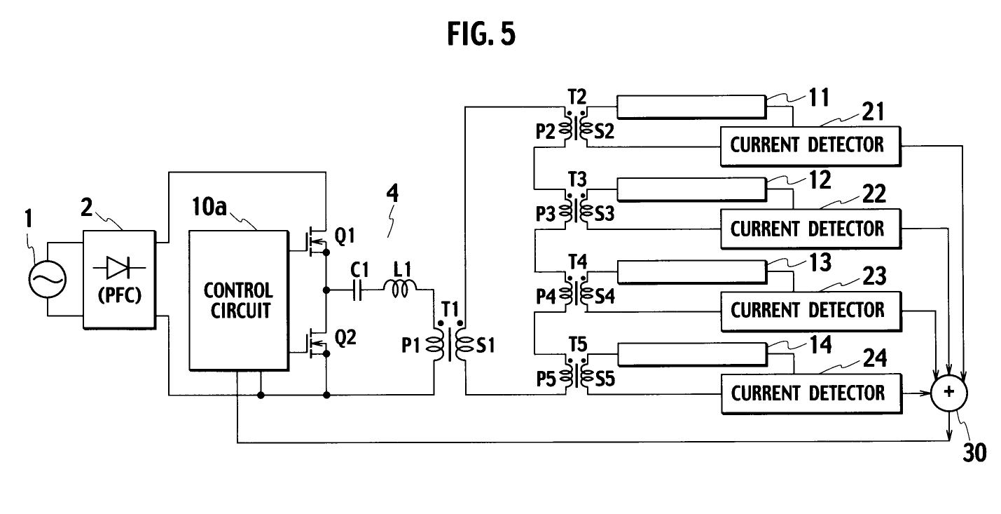

FIG. 5 is a diagram illustrating the configuration of an electric-discharge-lamp lighting apparatus according to Embodiment 3 of the present invention. The electric-discharge-lamp lighting apparatus of Embodiment 3 shown in FIG. 5 is an example of a case where the currents passing through the electric discharge lamps 11 to 14 are detected on the second-winding sides of the step-up transformers T2 to T5 (on the electric-discharge-lamp sides).

A series circuit including the electric discharge lamp 11 and a current detector 21 is connected to the two ends of the secondary winding S2 of the step-up transformer T2, and the current detector 21 detects the current passing through the electric discharge lamp 11. A series circuit including the electric discharge lamp 12 and a current detector 22 is connected to the two ends of the secondary winding S3 of the step-up transformer T3, and the current detector 22 detects the current passing through the electric discharge lamp 12. A series circuit including the electric discharge lamp 13 and a current detector 23 is connected to the two ends of the secondary winding S4 of the step-up transformer T4, and the current detector 23 detects the current passing through the electric discharge lamp 13. A series circuit including the electric discharge lamp 14 and a current detector 24 is connected to the two ends of the secondary winding S5 of the step-up transformer T5, and the current detector 24 detects the current passing through the electric discharge lamp 14. An adder 30 is provided to sum up the currents detected by the current detectors 21 to 24 and to output the total current thus obtained to a control circuit 10a.

Based on the total current obtained from the adder 30, the control circuit 10a executes an ON/OFF duty control to turn ON/OFF the switching element Q1 and the switching element Q2 alternately so that the current passing through the series circuit including primary winding P2 of the step-up transformer T2 to the primary winding P5 of the step-up transformer T5 connected in series with one another becomes to a predetermined value.

As has been described thus far, according to the electric-discharge-lamp lighting apparatus of Embodiment 3, the control circuit 10a executes an ON/OFF duty control to turn the switching element Q1 and the switching element Q2 alternately based on the total current obtained by summing up the currents detected by the current detectors 21 to 24. The control circuit 10a thus controls the current passing through the series circuit including primary winding P2 of the step-up transformer T2 to the primary winding P5 of the step-up transformer T5 connected in series to one another so that the current becomes to a predetermined value.

While the current detector 20 detects the current including the exciting current of the step-up transformers T2 to T5 in the electric-discharge-lamp lighting apparatus of Embodiment 1, the current detectors 21 to 24 directly detect respectively the currents passing through the electric discharge lamps 11 to 14 in Embodiment 3. Accordingly, the errors that might be caused by the exciting current of the step-up transformers T2 to T5 can be avoided, so that the electric discharge lamps 11 to 14 can be supplied with currents that are controlled with more accuracy.

Note that the reactor L1 may be eliminated from the configuration of the electric-discharge-lamp lighting apparatus of Embodiment 3 shown in FIG. 5 as in the case of the configuration of the electric-discharge-lamp lighting apparatus of Embodiment 2 shown in FIG. 4.

### Embodiment 4

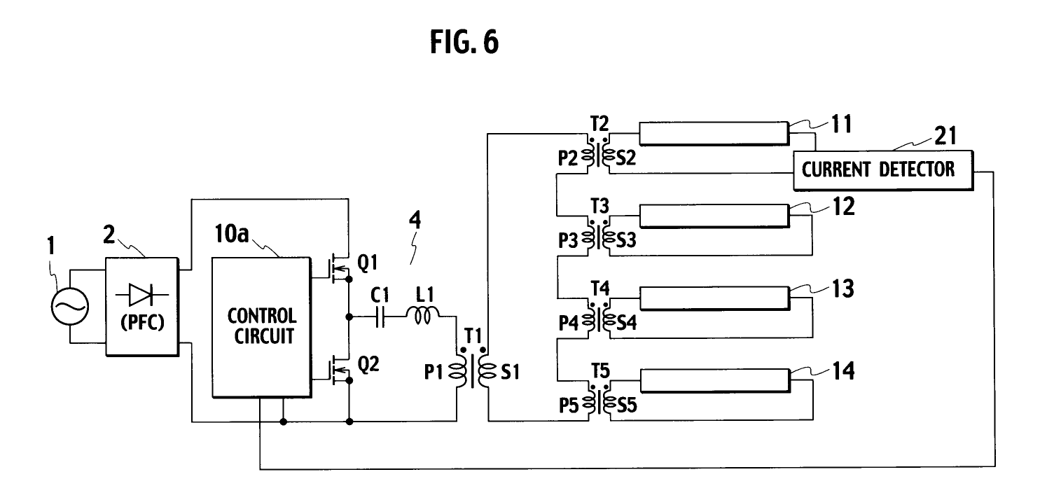

FIG. 6 is a diagram illustrating the configuration of an electric-discharge-lamp lighting apparatus according to Embodiment 4 of the present invention. In the electric-discharge-lamp lighting apparatus of Embodiment 3 shown in FIG. 5, the control circuit 10a controls the values of the currents passing through the electric discharge lamps 11 to 14 based on the total current obtained by the adder 30 from the currents detected by the current detectors 21 to 24.

On the other hand, the electric-discharge-lamp lighting apparatus of Embodiment 4 shown in FIG. 6 includes: a current detector 21 to detect the current passing through a series circuit including the electric discharge lamp 11 and the secondary winding S2 of the step-up transformer T2; and a control circuit 10a to turn ON/OFF the switching element Q1 and the switching element Q2 alternately, based on the current detected by the current detector 21, so that the current passing through a first series circuit including the primary winding P2 of the step-up transformer T2 to the primary winding P5 of the step-up transformer T5 connected in series to one another becomes to a predetermined value.

With this configuration, the electric-discharge-lamp lighting apparatus of Embodiment 4 can make the control circuit 10a control the values of the currents passing through the electric discharge lamps 11 to 14 by use of only the current detected by the current detector 21 without using the adder 30. Accordingly, the apparatus thus provided with a reduced number of current detectors is inexpensive.

Note that, in Embodiment 4, the current detector 21 is connected to the secondary winding S2 of the step-up transformer T2, but the current detector 21 may be connected to any one of the secondary winding S3 of the step-up transformer T3 to the secondary winding S5 of the step-up transformer T5.

### Embodiment 5

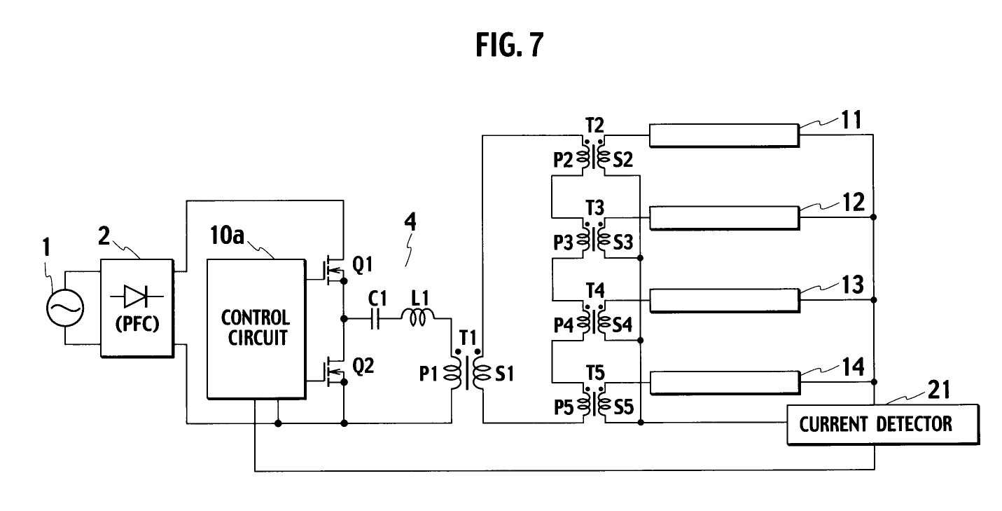

FIG. 7 is a diagram illustrating the configuration of an electric-discharge-lamp lighting apparatus according to Embodiment 5 of the present invention. In the electric-discharge-lamp lighting apparatus of Embodiment 3 shown in FIG. 5, the currents passing though the electric discharge lamps 11 to 14 and detected respectively by the current detectors 21 to 24 are summed up by the adder 30, and the resultant total current thus obtained is outputted to the control circuit 10a.

On the other hand, in the electric-discharge-lamp lighting apparatus of Embodiment 5 shown in FIG. 7, a current detector 21 is provided to detect the total current obtained by aggregating the currents passing through the electric discharge lamps 11 to 14, and the resultant total current thus detected is outputted to the control circuit 10a.

Four series circuits are provided: one including the secondary winding P2 of the step-up transformer T2 and the electric discharge lamp 11; another including the secondary winding P3 of the step-up transformer T3 and the electric discharge lamp 12, still another including the secondary winding P4 of the step-up transformer T4 and the electric discharge lamp 13; and the other including the secondary winding P5 of the step-up transformer T5 and the electric discharge lamp 14.

A first one of the two ends of the current detector 21 is connected to a first one of the two ends of each of the secondary winding S2 of the step-up transformer T2 to the secondary winding S5 of the step-up transformer T5 (to a first one of the two ends of each of the four series circuits) while the second end of the current detector 21 is connected to a first one of the two ends of each of the electric discharge lamps 11 to 14 (to the second end of each of the four series circuits). The current detector 21 thus connected detects the total current obtained by summing up the currents passing through the four series circuits.

The control circuit 10a turns ON/OFF the switching element Q1 and the switching element Q2 alternately, based on the total current detected by the current detector 21, so that the current passing through the first series circuit becomes to a predetermined value.

As has been described thus far, effects that are similar to the ones obtained by the electric-discharge-lamp lighting apparatus of Embodiment 3 are obtainable according to the electric-discharge-lamp lighting apparatus of Embodiment 5. In addition, the fewer current detectors allow the apparatus of Embodiment 5 to be inexpensive.

### Embodiment 6

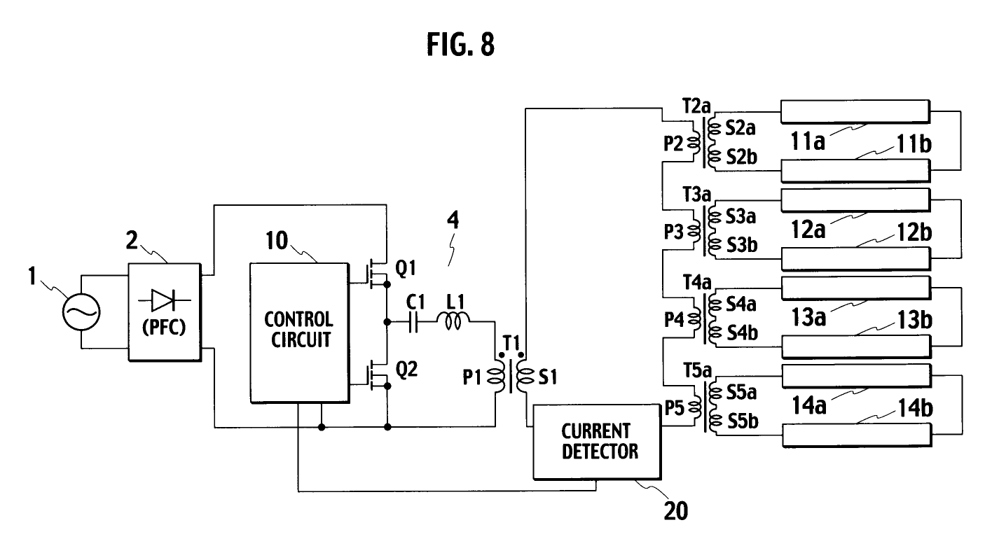

FIG. 8 is a diagram illustrating the configuration of an electric-discharge-lamp lighting apparatus according to Embodiment 6 of the present invention. In the electric-discharge-lamp lighting apparatus of Embodiment 6 shown in FIG. 8, a series circuit including an electric discharge lamp 11a and an electric discharge lamp 11b is connected to the two ends of a series circuit including a secondary winding S2a and a secondary winding S2b of a step-up transformer T2a. A series circuit including an electric discharge lamp 12a and an electric discharge lamp 12b is connected to the two ends of a series circuit including a secondary winding S3a and a secondary winding S3b of a step-up transformer T3a. A series circuit including an electric discharge lamp 13a and an electric discharge lamp 13b is connected to the two ends of a series circuit including a secondary winding S4a and a secondary winding S4b of a step-up transformer T4a. A series circuit including an electric discharge lamp 14a and an electric discharge lamp 14b is connected to the two ends of a series circuit including a secondary winding S5a and a secondary winding S5b of a step-up transformer T5a.

The rest of the configuration shown in FIG. 8 is identical to that of the configuration of the electric-discharge-lamp lighting apparatus of Embodiment 1 shown in FIG. 3.

As has been described thus far, according to the electric-discharge-lamp lighting apparatus of Embodiment 6, two electric discharge lamps are connected in series to one another and a single step-up transformer supplies the electric power to both of the two electric discharge lamps. Accordingly, the number of step-up transformers can be cut by half.

Note that the reactor L1 may be eliminated from the configuration of the electric-discharge-lamp lighting apparatus of Embodiment 6 shown in FIG. 8 as in the case of the configuration of the electric-discharge-lamp lighting apparatus of Embodiment 2 shown in FIG. 4.

### Embodiment 7

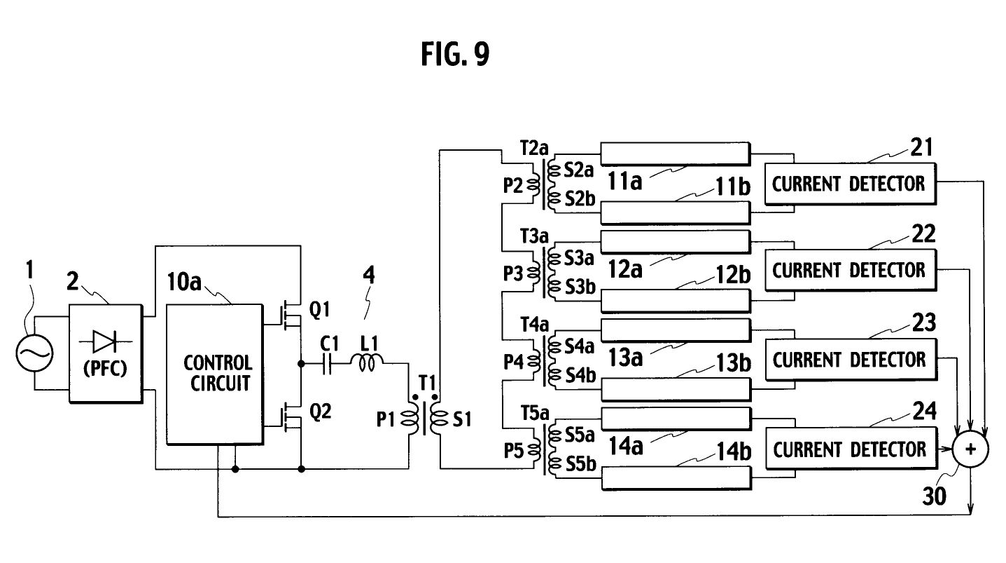

FIG. 9 is a diagram illustrating the configuration of an electric-discharge-lamp lighting apparatus according to Embodiment 7 of the present invention. The electric-discharge-lamp lighting apparatus of Embodiment 7 shown in FIG. 9 is an example of a case where the electric-discharge-lamp lighting apparatus of Embodiment 6 shown in FIG. 8 is modified so that the currents passing through the electric discharge lamps 11a and 11b to 14a and 14b are detected on the second-winding sides of the step-up transformer T2a to T5a (on the electric-discharge-lamp sides).

A series circuit including the electric discharge lamp 11a, a current detector 21, and the electric discharge lamp 11b is connected to the two ends of a series circuit including a secondary winding S2a and a secondary winding S2b of the step-up transformer T2a, and the current detector 21 detects the current passing through the electric discharge lamps 11a and 11b. A series circuit including the electric discharge lamp 12a, a current detector 22, and the electric discharge lamp 12b is connected to the two ends of a series circuit including a secondary winding S3a and a secondary winding S3b of the step-up transformer T3a, and the current detector 22 detects the current passing through the electric discharge lamps 12a and 12b.

A series circuit including the electric discharge lamp 13a, a current detector 23, and the electric discharge lamp 13b is connected to the two ends of a series circuit including a secondary winding S4a and a secondary winding S4b of the step-up transformer T4a, and the current detector 23 detects the current passing through the electric discharge lamps 13a and 13b. A series circuit including the electric discharge lamp 14a, a current detector 24, and the electric discharge lamp 14b is connected to the two ends of a series circuit including a secondary winding S5a and a secondary winding S5b of the step-up transformer T5a, and the current detector 24 detects the current passing through the electric discharge lamps 14a and 14b. The adder 30 is provided to sum up the currents detected by the current detectors 21 to 24 and to output the total current thus obtained to the control circuit 10a.

Based on the total current obtained from the adder 30, the control circuit 10a executes an ON/OFF duty control to turn ON/OFF the switching element Q1 and the switching element Q2 alternately so that the current passing through the series circuit including the primary winding P2 of the step-up transformer T2a to the primary winding P5 of the step-up transformer T5a connected in series to one another becomes to a predetermined value.

As has been described thus far, since the electric-discharge-lamp lighting apparatus of Embodiment 7 is formed by combining the electric-discharge-lamp lighting apparatus of Embodiment 3 and the electric-discharge-lamp lighting apparatus of Embodiment 6, the effects obtained by the electric-discharge-lamp lighting apparatus of Embodiment 3 and the effects obtained by the electric-discharge-lamp lighting apparatus of Embodiment 6 are obtainable according to the electric-discharge-lamp lighting apparatus of Embodiment 7.

Note that the reactor L1 may be eliminated from the configuration of the electric-discharge-lamp lighting apparatus of Embodiment 7 shown in FIG. 9 as in the case of the configuration of the electric-discharge-lamp lighting apparatus of Embodiment 2 shown in FIG. 4.

In addition, the configuration of the electric-discharge-lamp lighting apparatus of Embodiment 7 shown in FIG. 9 may be modified as in the case of the configuration of the electric-discharge-lamp lighting apparatus of Embodiment 4 shown in FIG. 6 so that only the current detector 21 will be provided and so that the electric-discharge-lamp lighting apparatus of Embodiment 7 can make the control circuit 10a control the values of the currents passing through the electric discharge lamps 11 to 14 by use of only the current detected by the current detector 21.

Moreover, the configuration of the electric-discharge-lamp lighting apparatus of Embodiment 7 shown in FIG. 9 may be modified as in the case of the configuration of the electric-discharge-lamp lighting apparatus of Embodiment 5 shown in FIG. 7 so that only the current detector 21 will be provided. Then, the electric-discharge-lamp lighting apparatus of Embodiment 7 can make the control circuit 10a control the values of the currents passing through the electric discharge lamps 11 to 14 by use of the total current detected by the current detector 21, the total current obtained by summing up the currents passing through the four series circuits.

### INDUSTRIAL APPLICABILITY

The present invention is applicable to an electric-discharge-lamp lighting apparatus configured to light plural electric discharge lamps, such as cold cathode fluorescent lamps, fluorescent lamps with external electrodes, and fluorescent lamps.

1. An electric-discharge-lamp lighting apparatus comprising:
an inverter that converts a DC voltage to a high-frequency voltage;
an insulating transformer for low voltage with a primary winding connected to an output end of the inverter; and
a plurality of step-up transformers,
wherein a first series circuit formed by connecting primary windings respectively of the plurality of step-up transformers in series to one another is connected to a secondary winding of the insulating transformer, and
one or more electric discharge lamps are connected to secondary windings respectively of the step-up transformers.

2. The electric-discharge-lamp lighting apparatus according to claim 1 wherein the inverter includes:
a DC power source which rectifies an AC voltage and which thereby outputs a DC voltage;
a second series circuit which is connected to two ends of the DC power source and which includes a first switching element and a second switching element connected in series to each other; and
a third series circuit which is connected both to a first end of the DC power source and to a point where the first switching element and the second switching element are connected to each other and which includes a reactor, a capacitor, and a primary winding of the insulating transformer connected in series to one another.

3. The electric-discharge-lamp lighting apparatus according to claim 1 wherein the inverter includes:
a DC power source which rectifies an AC voltage and which thereby outputs a DC voltage;
a second series circuit which is connected to two ends of the DC power source and which includes a first switching element and a second switching element connected in series to each other; and
a third series circuit which is connected both to a first end of the DC power source and to a point where the first switching element and the second switching element are connected to each other and which includes a capacitor and a primary winding of the insulating transformer connected in series to one another.

4. The electric-discharge-lamp lighting apparatus according to claim 2, further comprising a control unit that turns ON/OFF the first switching element and the second switching element alternately so that the current passing through the first series circuit becomes to a predetermined value.

5. The electric-discharge-lamp lighting apparatus according to claim 2, further comprising a control unit that turns ON/OFF the first switching element and the second switching element alternately so that the current passing through the first series circuit becomes to a predetermined value, based on a total current obtained by summing up, for all of the plurality of step-up transformers, currents passing through the one or more electric discharge lamps connected respectively to the secondary windings of the plurality of step-up transformers.

6. The electric-discharge-lamp lighting apparatus according to claim 2, further comprising a control unit that turns ON/OFF the first switching element and the second switching element alternately, based on currents passing through the one or more electric discharge lamps connected to the secondary windings of any one of the plurality of step-up transformers, so that the current passing through the first series circuit becomes to a predetermined value.

7. The electric-discharge-lamp lighting apparatus according to claim 3, further comprising a control unit that turns ON/OFF the first switching element and the second switching element alternately so that the current passing through the first series circuit becomes to a predetermined value.

8. The electric-discharge-lamp lighting apparatus according to claim 3, further comprising a control unit that turns ON/OFF the first switching element and the second switching element alternately so that the current passing through the first series circuit becomes to a predetermined value, based on a total current obtained by summing up, for all of the plurality of step-up transformers, currents passing through the one or more electric discharge lamps connected respectively to the secondary windings of the plurality of step-up transformers.

9. The electric-discharge-lamp lighting apparatus according to claim 3, further comprising a control unit that turns ON/OFF the first switching element and the second switching element alternately, based on currents passing through the one or more electric discharge lamps connected to the secondary windings of any one of the plurality of step-up transformers, so that the current passing through the first series circuit becomes to a predetermined value.
